(19) United States
(12) Patent Application Publication
(10) Pub. No.: US 2016/0100524 A1
(43) Pub. Date: Apr. 14, 2016

(54) HARVESTER

(71) Applicant: Young Living Essential Oils, LC, Lehi, UT (US)

(72) Inventor: D. Gary Young, Alpine, UT (US)

(21) Appl. No.: 14/879,060

(22) Filed: Oct. 8, 2015

Related U.S. Application Data
(60) Provisional application No. 62/061,582, filed on Oct. 8, 2014.

(51) Int. Cl. A01D 43/06; A01D 69/03; A01D 61/00; A01D 34/04; A01D 45/00

(52) U.S. Cl. CPC A01D 43/06; A01D 34/04; A01D 45/00; A01D 61/008; A01D 61/002; A01D 69/03

(57) ABSTRACT

A harvester apparatus, for harvesting crops for essential oil extraction, includes a longitudinal conveyor subsystem and a lateral conveyor subsystem. The longitudinal conveyor subsystem is positionable in crop receiving communication with a harvester header and is configured to convey a crop longitudinally rearward from the harvester header to a transition location. The lateral conveyor subsystem is disposed rearward of the longitudinal conveyor subsystem and in crop receiving communication with the longitudinal conveyor subsystem. The lateral conveyor subsystem is configured to convey the crop laterally from the longitudinal conveyor subsystem to an adjacent crop transport vehicle.

### FIELD

The subject matter of the present disclosure relates generally to a system for harvesting crops, and more particularly relates to a system for harvesting crops that inhibits evaporation of essential oil from the crop.

### BACKGROUND

Certain crops, such as plants that are specifically grown and harvested for the purpose of collecting aromatic oils (i.e., “essential oils”), have specific and somewhat unique characteristics that conventional harvesting techniques fail to account for. For example, crops that are grown for their aromatic oil should be harvested in such a way so as to prevent inadvertent and/or excessive evaporation of the contained oil during harvesting.

### SUMMARY

From the foregoing discussion, it should be apparent that a need exists for an apparatus and system for harvesting crops that overcome the limitations of conventional harvesting tools and procedures. Beneficially, such an apparatus and system would improve the ease, efficiency, and effectiveness of harvesting crops which are intended for essential oil extraction.

The subject matter of the present application has been developed in response to the present state of the art, and in particular, in response to the problems and needs in the art that have not yet been fully solved by currently available harvesting tools, methods and procedures. For example, the ease, efficiency, and effectiveness of harvesting crops which are intended for essential oil extraction is improved by preventing dirt and other contaminates from mixing with the reaped crop and by minimizing the surface area of the reaped crop that is exposed to air. Accordingly, the present disclosure has been developed to provide a system and apparatus that overcome many or all of the above-discussed shortcomings in the art.

Disclosed herein is one embodiment of a harvester apparatus for harvesting crops for essential oil extraction. The harvester apparatus includes a longitudinal conveyor subsystem and a lateral conveyor subsystem. The longitudinal conveyor subsystem is positionable in crop receiving communication with a harvester header and is configured to convey a crop longitudinally rearward from the harvester header to a transition location. The lateral conveyor subsystem is disposed rearward of the longitudinal conveyor subsystem and in crop receiving communication with the longitudinal conveyor subsystem. The lateral conveyor subsystem is configured to convey the crop laterally from the longitudinal conveyor subsystem to an adjacent crop transport vehicle.

In one implementation, the apparatus further includes a hydraulic pump subsystem that actuates both the longitudinal conveyor subsystem and the lateral conveyor subsystem. In another implementation, the lateral conveyor subsystem is configured to operate at a comparatively higher speed than the longitudinal conveyor subsystem. In one implementation, the lateral conveyor subsystem has two separate conveyors: a central conveyor and a delivery conveyor. In such an implementation, the delivery conveyor may be at least partially rotatable about a yaw axis or a pitch axis.

In one implementation, the transition location is configured to be underneath at least a portion of a tractor vehicle to which the harvester apparatus is coupled. In another implementation, the longitudinal conveyor subsystem and the lateral conveyor subsystem are covered to limit air exposure to the crop. In one implementation, the longitudinal conveyor subsystem at least partially overlaps the lateral conveyor subsystem and a vertical spacing between the longitudinal conveyor subsystem and the lateral conveyor subsystem is minimized.

Also disclosed herein is another embodiment of a harvester apparatus for harvesting crops for essential oil extraction. The harvester apparatus includes a supply conveyor, at least one central conveyor, and at least one delivery conveyor. The supply conveyor is positionable in crop receiving communication with a draper header and the supply conveyor is configured to convey a crop longitudinally rearward from the draper header. The at least one central conveyor is disposed rearward of the supply conveyor and in crop receiving communication with the supply conveyor. The at least one central conveyor is configured to convey the crop laterally from the supply conveyor. The at least one delivery conveyor is disposed lateral the at least one central conveyor and in crop receiving communication with the at least one central conveyor. The at least one delivery conveyor is configured to receive the crop from the at least one central conveyor and convey the crop upwardly and laterally into an adjacent crop transport vehicle.

In one implementation, the supply conveyor has a belt rotated by rollers and the rollers are about 2.5 inches in diameter. In another implementation, the apparatus further includes a hydraulic pump subsystem that actuates the supply conveyor, the at least one central conveyor, and the at least one delivery conveyor. The at least one delivery conveyor may be configured to operate at a comparatively higher speed than the supply conveyor. Also, the delivery conveyor may be at least partially rotatable about a yaw axis and/or a pitch axis. In one implementation, the apparatus is configured to operably convey the crop without allowing the crop to touch the ground.

Also disclosed herein is a harvester system for harvesting crops for essential oil extraction. The harvester system includes a tractor vehicle, draper header, a supply conveyor, at least one central conveyor, and at least one delivery conveyor. The tractor vehicle includes a front end and lateral sides and the draper header is coupled to the front end of the tractor vehicle. The draper header has a reel and a cutter bar configured to reap a crop and the draper header further includes two draper conveyors configured to direct the crop that has been reaped to an aft central location of the draper header. The supply conveyor is coupled to the tractor vehicle and is disposed rearward of the draper header. The supply conveyor is in crop receiving communication with the aft central location of the draper header and the supply conveyor is configured to convey the crop longitudinally rearward from the draper header. The at least one central conveyor is coupled to the tractor vehicle and disposed rearward of the supply conveyor. The at least one central conveyor is in crop receiving communication with the supply conveyor and the at least one central conveyor is configured to convey the crop laterally from the supply conveyor. The at least one delivery conveyor is coupled to the tractor vehicle and disposed lateral the at least one central conveyor. The at least one delivery conveyor is in crop receiving communication with the at least one central conveyor and the at least one delivery conveyor is configured to convey the crop upwardly and laterally from the at least one central conveyor to an adjacent crop transport vehicle.

In one implementation, the system further includes a hydraulic pump subsystem that actuates the draper header and the conveyors. The harvester system may be configured to operably reap and convey the crop without allowing the crop to touch the ground. In another implementation, the supply conveyor and the at least one central conveyor are positioned underneath a portion of the tractor vehicle and the at least one delivery conveyor is covered to limit air exposure to the crop. In such an implementation, the supply conveyor overlaps the at least one central conveyor and a vertical spacing between the supply conveyor and the at least one central conveyor is minimized.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the subject matter disclosed herein. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the subject matter of the present application may be practiced without one or more of the specific features or advantages of a particular embodiment. In other instances, additional features and advantages may be recognized in certain embodiments that may not be present in all embodiments of the disclosure. Further, in some instances, well-known structures, materials, or operations are not shown or described in detail to avoid obscuring aspects of the subject matter of the present disclosure. These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention, and are not therefore to be considered to be limiting of its scope, the invention will be described and explained with additional specificity and detail through the use of the accompanying drawings, in which:

FIG. 1 is a schematic depiction of a harvester system, according to one embodiment;

FIG. 2 is front schematic view of the harvester system, according to one embodiment;

FIG. 3A is a top schematic view of the harvester system, according to one embodiment;

FIG. 3B is a top schematic view of the harvester system, according another embodiment; and

FIG. 3C is a top schematic view of the harvester system, according to yet another embodiment.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

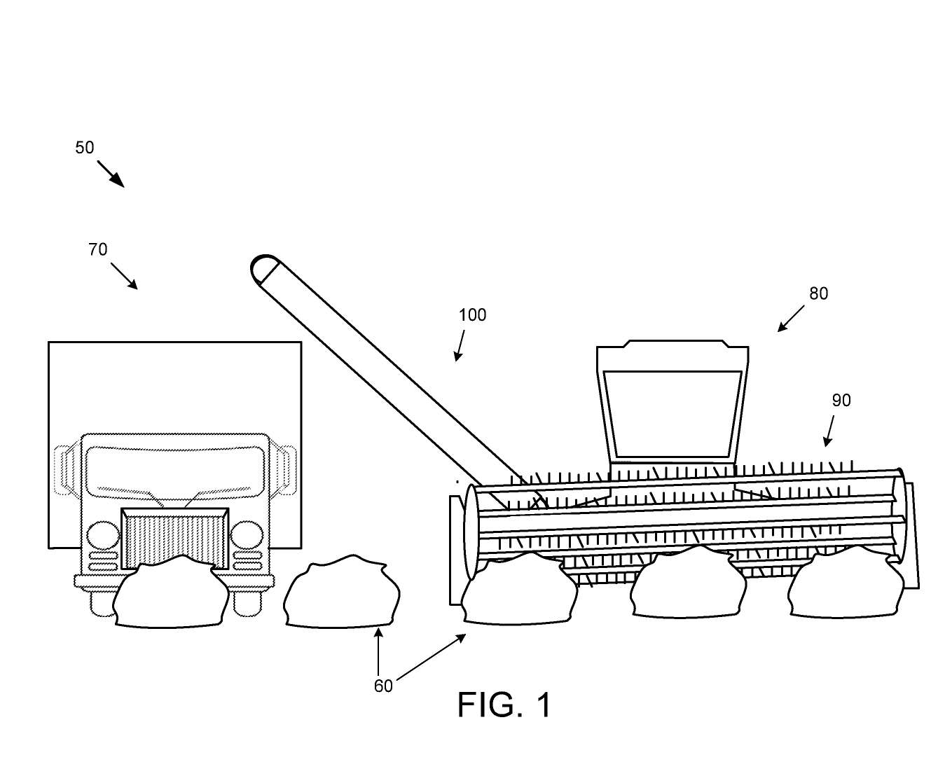

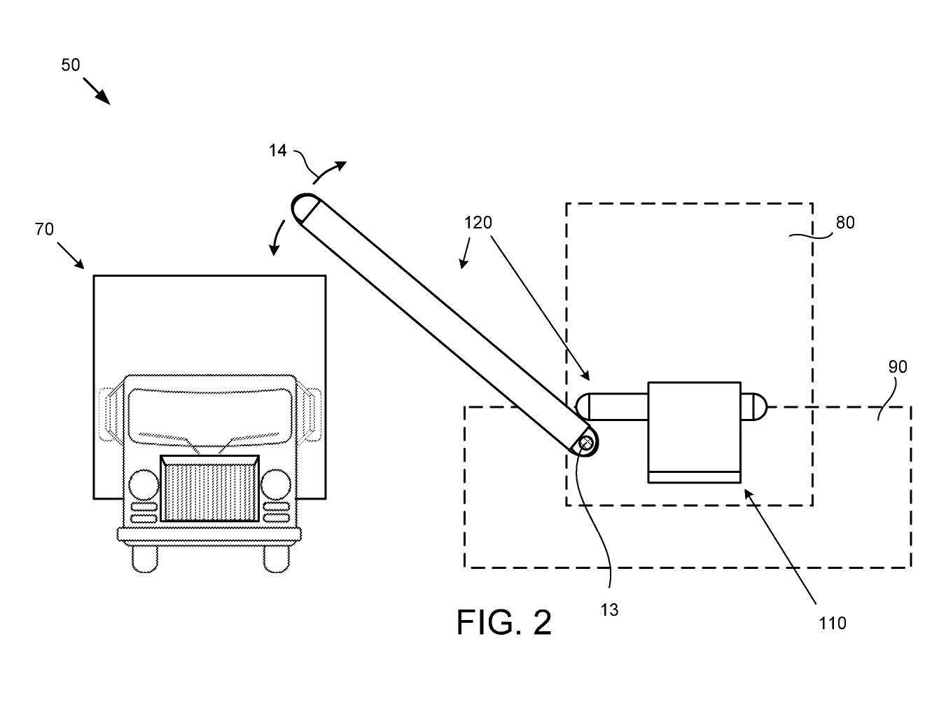

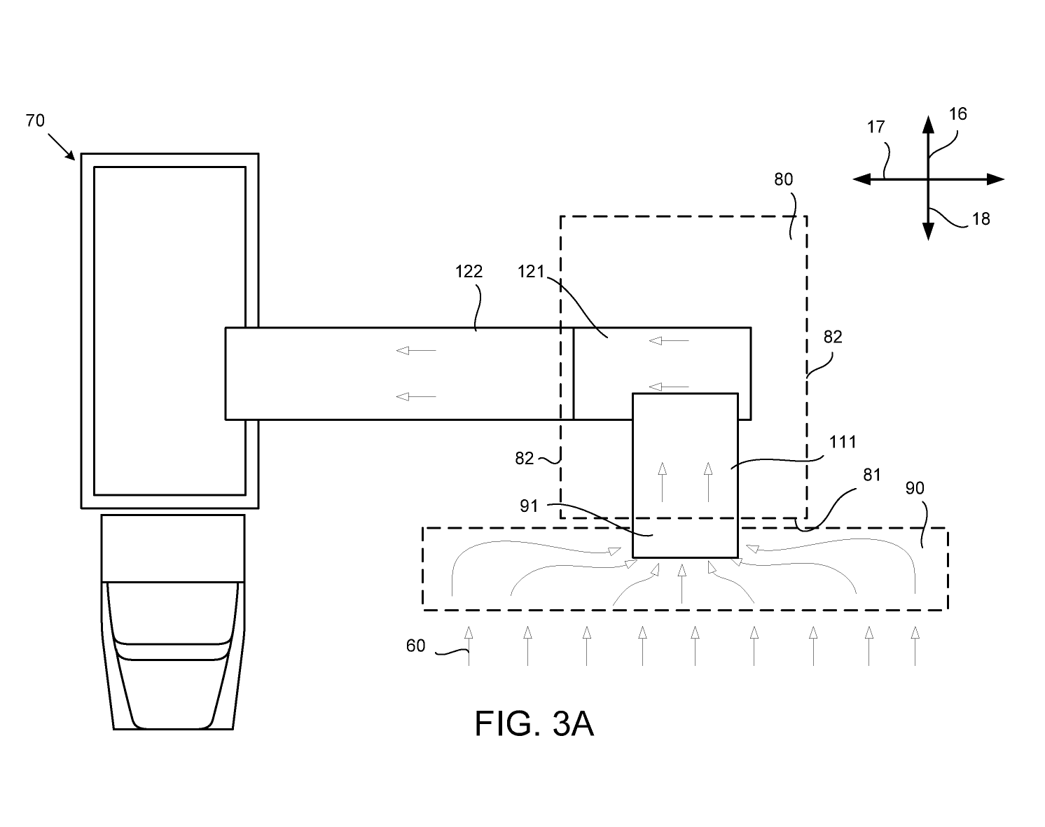

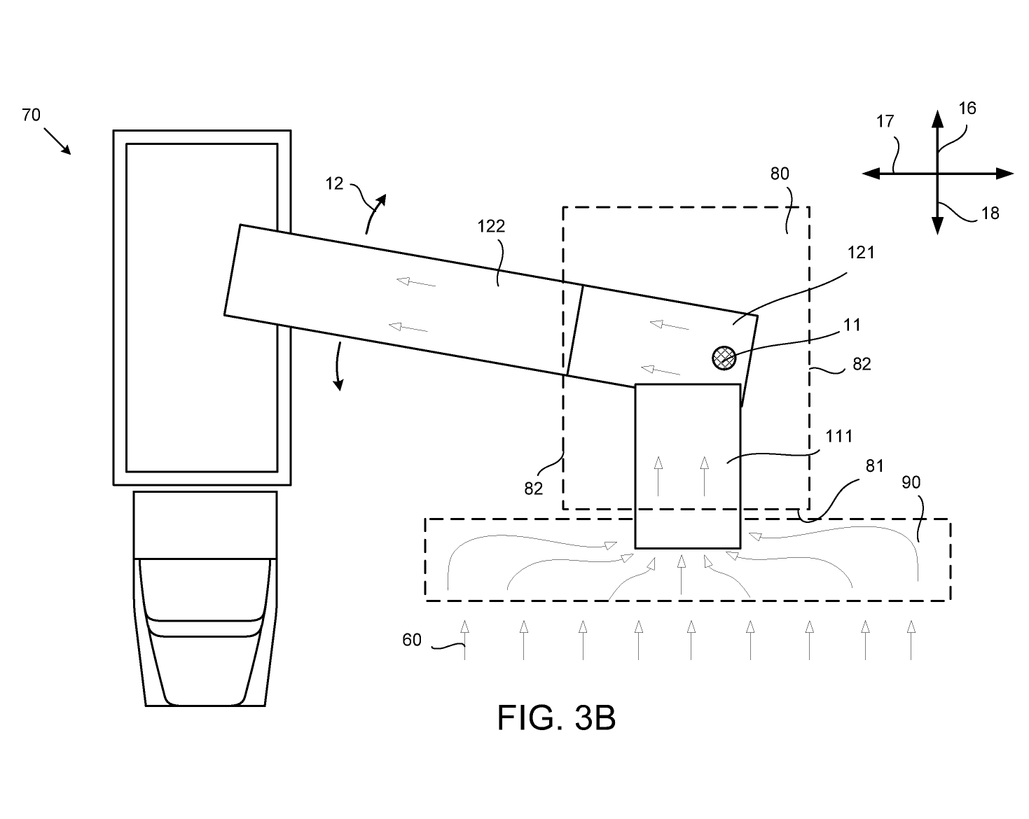

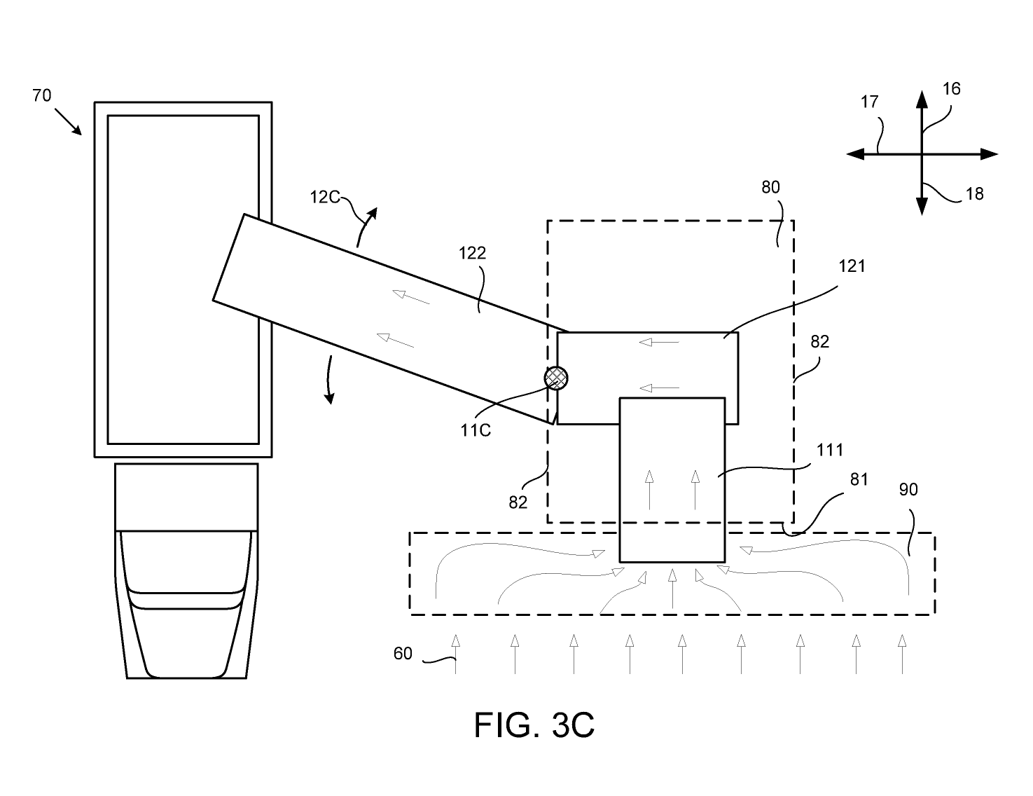

FIG. 1 is a schematic depiction of a harvester system 50, according to one embodiment. The system 50 includes a tractor vehicle 80 to which a harvester header 90 is coupled. Generally, the harvester header 90 reaps (i.e., cuts) a crop 60 and a harvester apparatus 100 (not depicted in FIG. 1, see FIGS. 2-3C) conveys the crop that has been reaped to an adjacent crop transport vehicle 70. As described below in greater detail with reference to the remaining figures, the harvester apparatus 100 of the harvester system 50 is configured to overcome certain deficiencies in conventional harvesting systems. For example, in one embodiment the harvester system 50 prevents, or at least inhibits, the crop 60 from touching the ground during the harvesting procedure.

As mentioned above in the background section, certain crops, such as plants that are specifically grown and harvested for the purpose of collecting aromatic oils (i.e., “essential oils”), have specific and somewhat unique characteristics that conventional harvesting techniques fail to account for. For example, crops that are grown for their aromatic oil should be harvested in such a way so as to prevent inadvertent and/or excessive evaporation of the contained oil during harvesting. One way to mitigate and prevent inadvertent aromatic oil loss during harvesting is to prevent dirt and other contaminates from mixing with the reaped crop and to minimize the surface area of the reaped crop that is exposed to air. In other words, maintaining the reaped crop off of the ground and preventing superfluous cutting, jostling, or shaking of the reaped crop to avoid increasing the evaporative flux of essential oil from the crop are factors that are implemented by the harvester system 50 and integrated harvester apparatus 100 of the present disclosure.

Suitable plants that may be harvested, in accordance with some embodiments, include, but are not limited to, the following plants (and related plant species): ajowan, allspice, aloe, ammi visnaga (khella), amyris, angelica, anise, arnica, balsam, basil, bay laurel, benzoin, bergamot, borage, boronia, buchu, calalmus, calendula, cannabis, caraway, cardamom, carnation, carrot, castor, catnip, chamomile (including blue chamomile, German chamomile, Moroccan chamomile, Moroccan wild chamomile, and Roman chamomile), champaca, cilantro, cistus, citronella, ciste, clary sage, clove, coriander, cornmint, costus, cumin, davana, dill, dill weed, erideron (fleabane), fennel, sweet fennel, fenugreek, galbanum, geranium, ginsing, helichrysum, hemp, honeysuckle, hyssop, immortelle, fragrant aster inula, jasmine, grandiflorum jasmine, jobquille, lanolin, lantana camara, lavender, lemongrass, lotus, marigold, marjarom, melissa, monarda, mugwort, myrrh, narcissus, neroli, oregano, orris, osmanthus, palmarosa, paprika, parsley, patchouli, pennyroyal, pepper, black pepper, peppermint, primrose, ravensara anisata, rose, rosehip, rosemary, rue, sage, sesame, shea, spikenard, spruce, St. John's wort, tagetes, thyme, tuberose, valerian, verbena, vetiver, violete, vitex, wintergreen, wormwood, and yarrow.

The tractor vehicle 80 may be any of various harvester vehicles that can be utilized to carry the harvester header 90. In one embodiment, the tractor vehicle 80 may have an existing hydraulic pump subsystem that not only actuates the typical functions of the tractor vehicle and the attached harvester header 90, the harvester apparatus 100 may also be actuated by the integrated hydraulic pump subsystem. In another embodiment, the harvester apparatus 100 (see below) includes a separate hydraulic pump subsystem that is independently actuated via a separate controller or that may be operably coupled to the integrated hydraulic subsystem so as to be actuated and controlled in conjunction with the harvester header 90. In other words, the harvester apparatus 100 may be implemented as an integrated feature on a newly manufactured tractor vehicle 80 or the harvester apparatus 100 may be retrofitted on an existing tractor vehicle 80.

The harvester header 90 may be any of various harvester heads. The selection and implementation of the harvester header 90 may be dependent on the type of crop 60 that is to be harvested. In one embodiment, for example, the harvester header 90 includes a cutter bar and a revolving reel. The cutter bar may be active (e.g., powered reciprocation) or the cutter bar may be fixed. The revolving reel may include teeth or other protrusions that facilitate cutting and depositing the crop into the header. Additionally, many headers include a cross auger that further facilitates in processing and conveying the reaped crop. In one embodiment, the harvester header 90 may be a draper header that includes an apron or engagement surface that guides the reaped crop laterally along the harvester header 90. The apron or engagement surface of the draper header, according to one embodiment, may be active and may include one or more roller driven belts or conveyors that convey the reaped crop to a desired location along the harvester header 90. In one embodiment, as described above, the crop transport vehicle 70 may be any of various cargo trucks that can carry and/or haul the reaped crop.

FIG. 2 is front schematic view of the harvester system 50, according to one embodiment. The tractor vehicle 80 and the mounted harvester header 90 are shown schematically as dotted lines. Generally, the harvester apparatus 100 is coupled to the tractor vehicle 80 and the mounted harvester header 90 and is disposed so as to convey the reaped crop from the harvester header 90 to the adjacent crop transport vehicle 70. In one embodiment, the harvester apparatus includes a longitudinal conveyor subsystem 110 and a lateral conveyor subsystem 120. Generally, the longitudinal conveyor subsystem 110 is positioned in crop receiving communication with the harvester header 90 in order to convey the reaped crop longitudinally rearward from the harvester header to the lateral conveyor subsystem 120. The lateral conveyor subsystem 120 is positioned rearward of the longitudinal conveyor subsystem 110 and in crop receiving communication with the longitudinal conveyor subsystem 110 in order to convey the crop laterally from the longitudinal conveyor subsystem 110 to the adjacent crop transport vehicle 70.

The conveyor subsystems 110, 120 may be any of various conveying mechanisms that are capable of transferring the reaped crop in the specified direction. In one embodiment, as depicted in the figures of the present disclosure, the conveyor subsystems 110, 120 may be conveyor belts on rollers. Additional details regarding examples and specific embodiments of the conveyor subsystems 110, 120 are included below with reference to FIGS. 3A-C. The conveyor subsystems 110, 120, as described above, may be coupled to the tractor vehicle 80 in a variety of configurations. For example, in one embodiment the conveyor subsystems 110, 120 are coupled to the tractor vehicle 80 so that the longitudinal conveyor subsystem 110 extends underneath a user cab portion of the tractor vehicle 80. The lateral conveyor subsystem 120 may be partially disposed underneath a portion of the tractor vehicle 80. The transition between the longitudinal conveyor subsystem 110 and the lateral conveyor subsystem 120 is defined herein as a transition location. The transition location may be underneath the tractor vehicle 80 where the two conveyor subsystems 110, 120 partially overlap, thus allowing the reaped crop from the longitudinal conveyor subsystem 110 to drop onto the lateral conveyor subsystem 120.

In one embodiment, the vertical spacing between conveyor subsystems 110, 120 (i.e., the distance the crops fall when transferring from the longitudinal conveyor subsystem 110 to the lateral conveyor subsystem 120) is minimized to reduce the flux (e.g., evaporative) of essential oil from the cut crops. For example, evaporative flux increases as the relative speed of the surrounding air/atmosphere increases. In other words, transitions between adjacent conveyors of the present system 50 and apparatus 100 are configured to reduce the extent of shaking and jostling that the crop experiences as it passes from the harvester header 90 to the crop transport vehicle 70, as opposed to the intended shaking, smashing, and otherwise agitating of wheat (e.g., threshing, winnowing) that occurs in more conventional harvesting systems. Accordingly, the conveyor subsystems 110, 120 may be covered or, as mentioned above, positioned below the cab or otherwise situated underneath the tractor vehicle 80 to limit exposing the crop to air, thereby limiting evaporation flux.

The lateral conveyor subsystem 120, according to one embodiment, may be an elevator-type conveyor that transfers the reaped crop laterally upward in order to fall into the bed of the crop transport vehicle. In one embodiment, the lateral conveyor subsystem 120 may be pivotably or rotatably coupled to the tractor vehicle 80 about a pitch axis 13. Accordingly, lateral conveyer subsystem 120 may be actuated to rotate in a pitch direction 14 about the pitch axis 13, thus allowing the user (via user interface controls or an automated controller) to control the pitch of the lateral conveyor subsystem 120.

The actuation of the conveyor subsystems 110, 120 may be via a hydraulic pump subsystem. Fluid flow actuators may be implemented to control the operation of the hydraulics. A user may actuate the hydraulics via a user interface, such as levers, knobs, controls, buttons, pedals, etc. In another embodiment, a controller may be implemented with the system 50 and may include various modules that control and manage the operation of the system 50. As described above, the controller for the harvester apparatus 100 (conveyer subsystems 110, 120) may be separate from the main controller of the tractor vehicle 80 or integrated therewith. Additionally, the harvester header 90 may actuated via the same hydraulic pump subsystem, thereby promoting association and synchronization between the harvester header 90 and the conveyer subsystems 110, 120 of the harvester apparatus 100. The harvester apparatus 100 may further include one or more gearing assemblies to control the operation (i.e., speed) of the conveyors. In one embodiment, the lateral conveyor subsystem 120 operates at a higher speed than the longitudinal conveyor subsystem 110.

In one embodiment, the lateral conveyor subsystem 120 may be a single conveyor. In another embodiment, as shown in FIG. 2, the lateral conveyor subsystem 120 includes two conveyors, a central conveyor and a deliver conveyor. Additional details relating to these conveyors are described below with reference to FIGS. 3A-C.

FIG. 3A is a top schematic view of the harvester system 50, according to one embodiment. Similar to FIG. 2, the tractor vehicle 80 and the mounted harvester header 90 are shown schematically in FIGS. 3A-C with dotted lines. Also, FIGS. 3A-C include an orientation axis that shows the various general directions referenced throughout the disclosure. The rearward direction 16 points opposite the forward direction 18 (also known as, the movement direction of the tractor vehicle 80) and the lateral direction 17 extends outwardly from lateral sides 82 of the tractor vehicle 80. In one embodiment, the longitudinal conveyor subsystem 110 may be a supply conveyor 111 and the lateral conveyor subsystem 120, which conveys reaped crop laterally outward from the supply conveyor 111, may include a central conveyor 121 and a delivery conveyor 122. In other words, the harvester apparatus may include three conveyors 111, 121, 122.

FIG. 3A also includes a schematic depiction of the reaped crop 60 movement across and/or through the various components of the system 50. According to one embodiment, the reaped crop may first be cut from the ground by the cutter edge of the harvester header 90 and then transferred to an aft central location 91 of the harvester header 90. The transfer across the harvester header 90 may be performed by active draper conveyors. In one embodiment, the reaped crop 60 is then received by the supply conveyer 111 and transferred longitudinally rearward until the crop reaches the central conveyor 121. The central conveyor 121 may not be centralized with respect to the tractor vehicle 80 and may direct/transfer the crop to the delivery conveyor 122.

The conveyors 111, 121, 122 may be belts rotated by rollers. The belts may be made from a flexible material. Further, the exterior surface of the belts may have steps or protrusions that facilitate the transfer of the crop along the length of the conveyor. For example, the delivery conveyor 122 may have steps that pull the crop upwards. The size and dimensions of the conveyors 111, 121, 122 may be selected according to the specifics of a given application. In one embodiment, for example, the supply conveyor 111 may have 2.5 inch rollers around which and by which a belt is driven. The conveyors 111, 121, 122 may also have sidewalls or may be partially enclosed so as to form chutes, thus preventing contaminants (e.g., dirt) from contacting the crop and preventing the crop from falling off of the conveyors 111, 121, 122. The power system that drives the conveyors may be hydraulic, electric, etc. The conveyors 111, 121, 122 may all operate at substantially the same speed (which may match the speed of the draper conveyors) or may operate at different speeds. For example, the delivery conveyor 122 may have an operation speed that is comparatively higher than the central conveyor 121, which in turn has a comparatively higher operation speed than the supply conveyor 111.

Referring to FIG. 3B, the lateral conveyor subsystem 120, the central conveyor 121 and the delivery conveyor 122, may be at least partially rotatable about a yaw axis 11 to allow movement of the delivery conveyor 122 in a yaw direction 12. In other words, the apparatus may be actuated so that the lateral extension direction of the delivery conveyor 122 is not exactly perpendicular to the longitudinal direction. In such an embodiment, the position of the delivery conveyor 122 can be further customized, according to the position of the crop transport vehicle. With reference to FIG. 3C, the yaw axis 11C may be between the central conveyor 121 and the delivery conveyor 122, thus still allowing the delivery conveyor 122 to be moved in a yaw direction 12C according to the specifics of a given application or a specific harvesting condition.

While the figures of the present disclosure only show the delivery conveyor 122 extending laterally from one side of the tractor vehicle 80, it is expected that two delivery conveyors, one from each lateral side of the tractor vehicle 80, may extend from two central conveyors, thus allowing crop to be simultaneously loaded into two crop transport vehicles 70.

In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A harvester apparatus for harvesting crops for essential oil extraction, the apparatus comprising:
a longitudinal conveyor subsystem positionable in crop receiving communication with a harvester header, the longitudinal conveyor subsystem configured to convey a crop longitudinally rearward from the harvester header to a transition location; and
a lateral conveyor subsystem disposed rearward of the longitudinal conveyor subsystem and in crop receiving communication with the longitudinal conveyor subsystem, the lateral conveyor subsystem configured to convey the crop laterally from the longitudinal conveyor subsystem to an adjacent crop transport vehicle.

2. The apparatus of claim 1, wherein the apparatus further comprises a hydraulic pump subsystem that actuates both the longitudinal conveyor subsystem and the lateral conveyor subsystem.

3. The apparatus of claim 1, wherein the lateral conveyor subsystem is configured to operate at a comparatively higher speed than the longitudinal conveyor subsystem.

4. The apparatus of claim 1, wherein the lateral conveyor subsystem comprises two separate conveyors: a central conveyor and a delivery conveyor.

5. The apparatus of claim 4, wherein the delivery conveyor is at least partially rotatable about a yaw axis.

6. The apparatus of claim 4, wherein the delivery conveyor is at least partially rotatable about a pitch axis.

7. The apparatus of claim 1, wherein the transition location is configured to be underneath at least a portion of a tractor vehicle to which the harvester apparatus is coupled.

8. The apparatus of claim 1, wherein the longitudinal conveyor subsystem and the lateral conveyor subsystem are covered to limit air exposure to the crop.

9. The apparatus of claim 1, wherein the longitudinal conveyor subsystem at least partially overlaps the lateral conveyor subsystem, wherein a vertical spacing between the longitudinal conveyor subsystem and the lateral conveyor subsystem is minimized.

10. A harvester apparatus for harvesting crops for essential oil extraction, the apparatus comprising:
a supply conveyor positionable in crop receiving communication with a draper header, the supply conveyor configured to convey a crop longitudinally rearward from the draper header;
at least one central conveyor disposed rearward of the supply conveyor and in crop receiving communication with the supply conveyor, the at least one central conveyor configured to convey the crop laterally from the supply conveyor; and
at least one delivery conveyor disposed lateral the at least one central conveyor and in crop receiving communication with the at least one central conveyor, the at least one delivery conveyor configured to receive the crop from the at least one central conveyor and convey the crop upwardly and laterally into an adjacent crop transport vehicle.

11. The apparatus of claim 10, wherein the supply conveyor comprises a belt rotated by rollers, wherein the rollers are about 2.5 inches in diameter.

12. The apparatus of claim 10, wherein the apparatus further comprises a hydraulic pump subsystem that actuates the supply conveyor, the at least one central conveyor, and the at least one delivery conveyor.

13. The apparatus of claim 10, wherein the at least one delivery conveyor is configured to operate at a comparatively higher speed than the supply conveyor.

14. The apparatus of claim 10, wherein the delivery conveyor is at least partially rotatable about a yaw axis.

15. The apparatus of claim 10, wherein the delivery conveyor is at least partially rotatable about a pitch axis.

16. The apparatus of claim 10, wherein the apparatus is configured to operably convey the crop without allowing the crop to touch the ground.

17. A harvester system for harvesting crops for essential oil extraction, the harvester system comprising:
a tractor vehicle comprising a front end and lateral sides;
a draper header coupled to the front end of the tractor vehicle, the draper header comprising a reel and a cutter bar configured to reap a crop, the draper header further comprising two draper conveyors configured to direct the crop that has been reaped to an aft central location of the draper header;
a supply conveyor coupled to the tractor vehicle and disposed rearward of the draper header, the supply conveyor in crop receiving communication with the aft central location of the draper header, the supply conveyor configured to convey the crop longitudinally rearward from the draper header;
at least one central conveyor coupled to the tractor vehicle and disposed rearward of the supply conveyor, the at least one central conveyor in crop receiving communication with the supply conveyor, the at least one central conveyor configured to convey the crop laterally from the supply conveyor; and
at least one delivery conveyor coupled to the tractor vehicle and disposed lateral the at least one central conveyor, the at least one delivery conveyor in crop receiving communication with the at least one central conveyor, the at least one delivery conveyor configured to convey the crop upwardly and laterally from the at least one central conveyor to an adjacent crop transport vehicle.

18. The harvester system of claim 17, further comprising a hydraulic pump subsystem that actuates the draper header and the conveyors.

19. The harvester system of claim 17, wherein the harvester system is configured to operably reap and convey the crop without allowing the crop to touch the ground.

20. The harvester system of claim 17, wherein the supply conveyor and the at least one central conveyor are positioned underneath a portion of the tractor vehicle and the at least one delivery conveyor is covered to limit air exposure to the crop, wherein the supply conveyor overlaps the at least one central conveyor, wherein a vertical spacing between the supply conveyor and the at least one central conveyor is minimized.
